(19) United States
(12) Patent Application Publication
(10) Pub. No.: US 2015/0110617 A1
(43) Pub. Date: Apr. 23, 2015

(54) TURBINE AIRFOIL INCLUDING TIP FILLET

(71) Applicant: General Electric Company, Schenectady, NY (US)

(72) Inventors: Alexander Stein, Simpsonville, SC (US); Lee Larned Brozyna, Mauldin, SC (US); Mark Andrew Jones, Greer, SC (US)

(73) Assignee: General Electric Company, Schenectady, NY (US)

(21) Appl. No.: 14/061,169

(22) Filed: Oct. 23, 2013

(51) Int. Cl. F01D 5/20; F01D 9/04

(52) U.S. Cl. CPC F01D 5/20; F01D 9/041; F05D 2240/307
USPC 415/208.1; 416/223 R

(57) ABSTRACT

A turbine blade can include a root configured to connect to a turbine and supporting an airfoil configured to extend into a flowpath of the turbine. The airfoil can include a tip disposed substantially opposite the root and a first tip fillet disposed proximate the tip that can extend substantially perpendicular to a local flow direction at points along a surface of the turbine blade over the extremity of the first tip fillet. The tip fillet can enhance performance of the turbine by beneficially altering flow through a stage in which the blade is included.

### BACKGROUND OF THE INVENTION

The subject matter disclosed herein relates to turbine components for aircraft and power generation applications, and, more specifically, to turbine components including an airfoil portion having a tip fillet, the tip fillet increasing a thickness of the airfoil proximate a tip of the airfoil span.

Some aircraft and/or power plant systems, for example certain jet aircraft, nuclear, simple cycle and combined cycle power plant systems, employ turbines in their design and operation. Some of these turbines include one or more stages of buckets which during operation are exposed to fluid flows. Each bucket can include a base supporting a respective airfoil (e.g., turbine blade, blade, etc.) configured to aerodynamically interact with and extract work from fluid flow (e.g., creating thrust, driving machinery, converting thermal energy to mechanical energy, etc.) as part of, for example, power generation. As a result of this interaction and conversion, the aerodynamic characteristics and losses of these airfoils have an impact on system and turbine operation, performance, thrust, efficiency, and power at each stage.

In these systems, a source of aerodynamic loss and inefficiency can include overtip leakage, particularly in unshrouded gas turbine blades. During operation, portions of the fluid flow may leak over a tip of the airfoil (e.g., between a blade tip and flowpath sidewall of the turbine, through the blade clearance gap, etc.) and form a vortex on a suction side of the airfoil. This leakage and subsequent vortex formation on the suction side may cause a pressure gradient to form across the tip and/or through the blade clearance gap, thereby impacting the fluid flow and efficiency of the system and airfoil, and hindering device performance.

### BRIEF DESCRIPTION OF THE INVENTION

A turbine component including a tip fillet on a radial end (e.g., tip) of an airfoil is disclosed.

An embodiment of the invention disclosed herein can take the form of a turbine blade having a root configured to connect to a turbine and an airfoil connected to the root and configured to extend into a flowpath of the turbine. The airfoil can include a tip disposed substantially opposite the root, as well as a first tip fillet disposed on the tip and extending substantially away from a first surface of the turbine blade.

Another embodiment of the invention disclosed herein can be implemented in a turbine component that can include a root configured to connect to a turbine and a blade disposed on the root and configured to extend into a turbine flowpath. The blade can have an airfoil shape and can include a tip. A tip fillet can be connected to the tip and can extend from a surface of the turbine component.

An additional embodiment of the invention disclosed herein can take the form of a turbine having a nozzle including a casing and at least one blade, a rotor including a hub and at least one blade, and a working fluid passage including a first portion substantially surrounded by the nozzle casing and a second portion substantially surrounding the rotor hub. Each blade can include a root configured to connect to one of the nozzle casing or the rotor hub, as well as an airfoil connected to the root and configured to extend into the working fluid passage of the turbine. The airfoil can have a tip disposed substantially opposite the root, and a first tip fillet can be disposed on the tip. The tip fillet can extend from a surface of the turbine component in a direction substantially perpendicular to a local flow direction at points along a surface of the turbine component over the extremity of the first tip fillet.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a three-dimensional partial cut-away perspective view of a portion of a turbine according to an embodiment of the invention;

FIG. 2 shows a turbine component in accordance with embodiments of the invention;

FIG. 3 shows a tip portion of a turbine component in accordance with embodiments of the invention;

FIG. 4 shows an airfoil including a tip fillet in accordance with embodiments of the invention;

FIG. 5 shows a graphical representation of an airfoil thickness function according to an embodiment;

FIG. 6 shows a graphical representation of a tip fillet thickness function according to an embodiment;

FIG. 7 shows a side view of a turbine airfoil including a tip fillet according to an embodiment;

FIG. 8 shows a cross sectional view of the turbine airfoil of FIG. 7 along view line A-A;

FIG. 9 shows a cross sectional view of the turbine airfoil of FIG. 7 along view line B-B;

FIG. 10 shows a cross sectional view of the turbine airfoil of FIG. 7 along view line C-C;

FIG. 11 shows a side view of a turbine airfoil including a one-sided tip fillet according to an embodiment;

FIG. 12 shows a side view of a turbine airfoil including a set of tip fillets according to an embodiment;

FIG. 13 shows a schematic block diagram illustrating portions of a combined cycle power plant system according to embodiments of the invention; and

FIG. 14 shows a schematic block diagram illustrating portions of a single-shaft combined cycle power plant system according to embodiments of the invention.

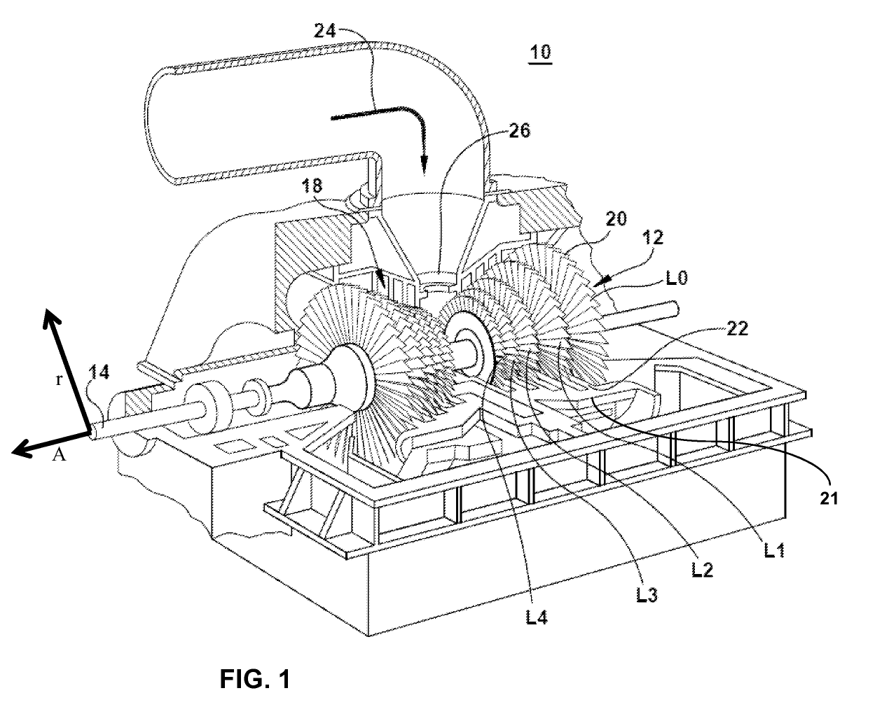

It is noted that the drawings of the invention are not necessarily to scale. The drawings are intended to depict only typical aspects of the invention, and therefore should not be considered as limiting the scope of the invention. It is understood that elements similarly numbered between the FIGURES may be substantially similar as described with reference to one another. Further, in embodiments shown and described with reference to FIGS. 1-14, like numbering may represent like elements. Redundant explanation of these elements has been omitted for clarity. Finally, it is understood that the components of FIGS. 1-14 and their accompanying descriptions may be applied to any embodiment described herein.

### DETAILED DESCRIPTION OF THE INVENTION

Aspects of the invention provide for a turbine component including a tip fillet on a portion of an airfoil section, the tip fillet increasing a thickness of the airfoil proximate a radial extent of the airfoil.

In contrast to conventional approaches, aspects of the invention include a turbine component (e.g., turbine blade, turbine nozzle, blade, etc.) having a tip fillet disposed on a portion of the turbine component and configured to reduce tip leakage. In an embodiment, the tip fillet extends from a surface of the turbine component in a direction substantially perpendicular to a local flow direction at points along the surface of the turbine component over the extremity of the tip fillet. The tip fillet may overhang the blade/airfoil and/or a tip vortex location of the turbine component, the tip vortex forming during operation/exposure of the turbine component to a fluid flow. The tip fillet can reduce tip vortex formation and tip leakage, thereby inhibiting formation of a pressure gradient across a tip of the airfoil and assisting with improvement of aerodynamic performance.

As used herein, the terms “axial” and/or “axially” refer to the relative position/direction of objects along axis A, which is substantially parallel to the axis of rotation of the turbomachine (in particular, the rotor section). As further used herein, the terms “radial” and/or “radially” refer to the relative position/direction of objects along axis (r), which is substantially perpendicular with axis A and intersects axis A at only one location. Additionally, the terms “circumferential” and/or “circumferentially” refer to the relative position/direction of objects along a circumference which surrounds axis A but does not intersect the axis A at any location. Further, the term “leading edge” refers to components and/or surfaces which are oriented upstream relative to the fluid flow of the system, and the term “trailing edge” refers to components and/or surfaces which are oriented downstream relative to the fluid flow of the system.

Turning to the FIGURES, embodiments of systems and devices are shown, which can be configured to reduce tip leakage losses in a turbine by providing a tip fillet disposed proximate a radial extent/tip of a turbine component. Each of the components in the FIGURES may be connected via conventional means, e.g., via a common conduit or other known means as is indicated in FIGS. 1-14. Referring to the drawings, FIG. 1 shows a perspective partial cut-away illustration of a gas or steam turbine 10. Turbine 10 includes a rotor 12 that includes a rotating shaft 14 and a plurality of axially spaced rotor wheels 18. A plurality of rotating blades or buckets 20 are mechanically coupled to each rotor wheel 18. More specifically, buckets 20 are arranged in rows that extend circumferentially around each rotor wheel 18. A nozzle 21 can include a plurality of stationary blades or vanes 22 that can extend circumferentially around shaft 14, and the vanes are axially positioned between adjacent rows of buckets 20. Stationary vanes 22 cooperate with buckets 20 to form a stage and to define a portion of a flow path through turbine 10. For example, each vane 22 can extend radially inward into the flow path from a root attached to a casing or the like of a nozzle 21 to a radially inward tip, while each bucket 20 can extend radially outward into the flow path from a root attached to a hub or the like of a rotor wheel 18 to a radially outward tip.

In operation, gas 24 enters an inlet 26 of turbine 10 and is channeled through stationary vanes 22. Vanes 22 direct gas 24 against blades 20. Gas 24 passes through the remaining stages imparting a force on buckets 20 causing shaft 14 to rotate. At least one end of turbine 10 may extend axially away from rotating shaft 12 and may be attached to a load or machinery (not shown) such as, but not limited to, a generator, and/or another turbine, such as might be used in aviation and/or other applications.

In the example shown in FIG. 1, turbine 10 can include five stages identified as a first stage L4, a second stage L3, a third stage L2, a fourth stage L1, and a fifth stage L0, which is also the last stage. Each stage has a respective radius, with first stage L4 having the smallest radius of the five stages and each subsequent stage having a larger radius, with fifth stage L0 having a largest radius of the five stages. While five stages are shown in FIG. 1, this simply a non-limiting example, and the teachings herein can be applied to turbines having more or fewer stages, including a turbine with a single stage. In addition, while the example shown in FIG. 1 is stationary, the teachings herein can be applied to any suitable turbine, including turbines used in aircraft engines, and may also be applied to compressors.

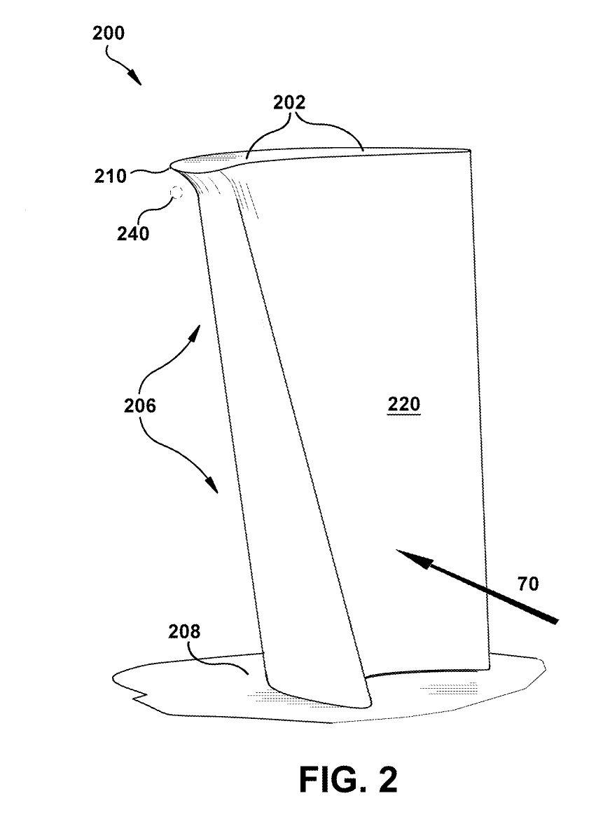

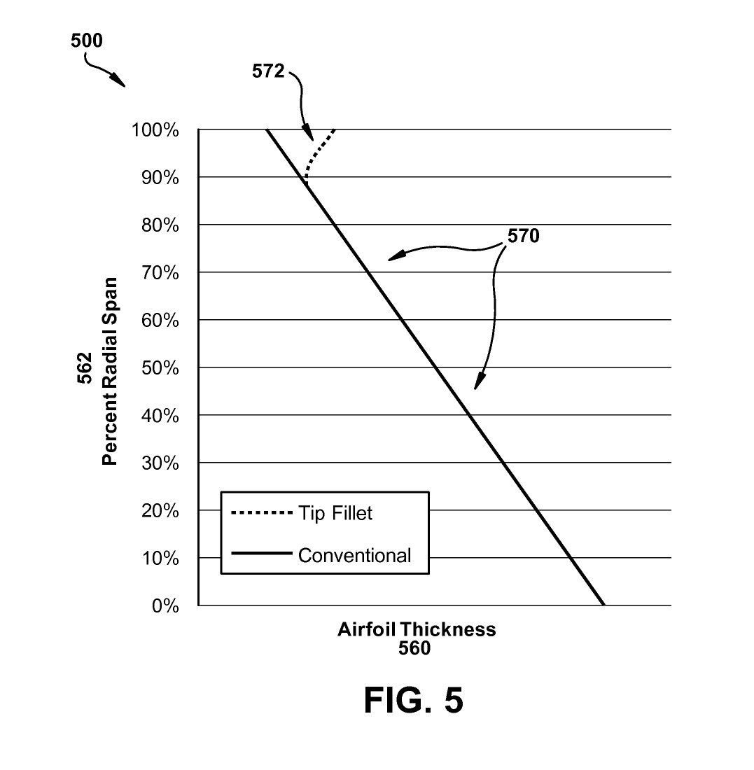

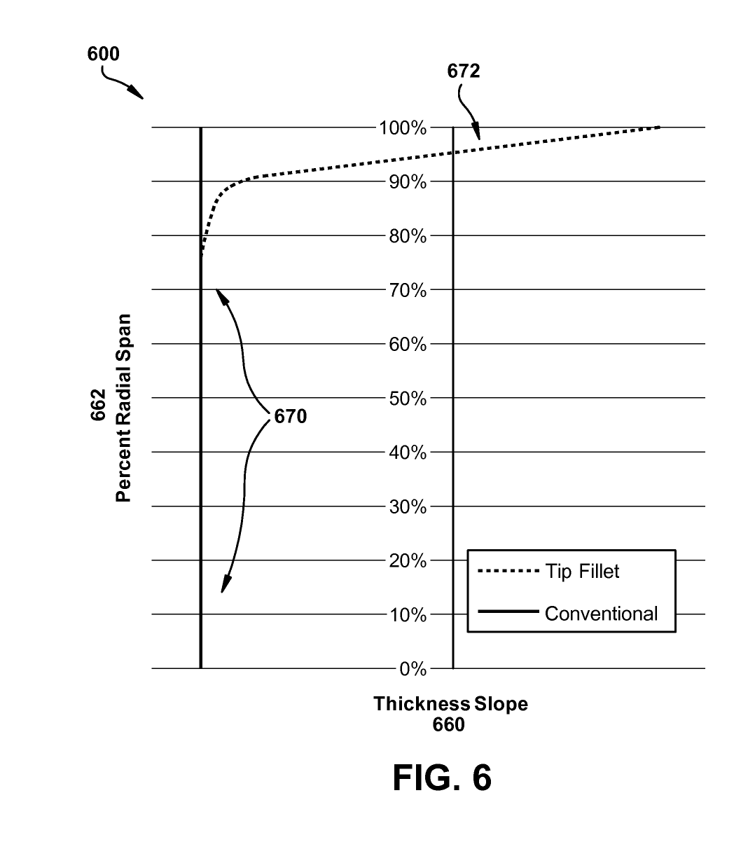

Turning to FIG. 2, a turbine component 200 (e.g., a turbine blade, a blade, a bucket, a vane, etc.) is shown including an airfoil 220 with a tip fillet 210 in accordance with embodiments of the invention. In an embodiment, tip fillet 210 is disposed proximate a tip 202 of turbine component 200 and extends/protrudes from a first flow surface 206 of turbine component 200. Tip fillet 210 may extend across a width of turbine component 200 and may substantially overhang portions of the blade/airfoil between tip 202 and a root 208 of turbine component 200. In one embodiment, tip fillet 210 may have a concave shape and/or may flare out from first flow surface 206. In another embodiment, tip fillet 210 may have a linear shape or a convex shape. Where turbine component 200 includes a dynamic blade or bucket, airfoil 220 may extend outboard or radially outward from root 208 to tip 202, root 208 being attached, for example, to a casing or the like of a nozzle 21 of turbine 10. Where turbine component 200 includes a stationary blade or vane, airfoil 220 may extend inboard or radially inward from root 208 to tip 202, root 208 being attached, for example, to a hub of a rotor 18 of turbine 10. In either case, tip fillet 210 may extend substantially into a fluid path 70 from a suction side of airfoil 220 and/or substantially perpendicular to direction of fluid flow 70 so as to overhang a location of a tip vortex 240 (shown in phantom). In one embodiment, tip fillet 210 may extend from a leading edge of airfoil 220 substantially into fluid flow 70. In another embodiment, tip fillet 210 may extend in a direction substantially perpendicular to the direction of fluid flow 70 from a pressure side of airfoil 220. First flow surface 206 may be a suction side of turbine component 200 relative to the direction of fluid flow 70 in turbine 100 (shown in FIG. 1). In one embodiment, tip fillet 210 may increase a cross-sectional dimension (e.g., thickness) of turbine component 200 relative to an adjacent cross sectional portion of turbine component 200 (as shown in FIGS. 5 and 6). In one embodiment, tip fillet 210 may be formed as a portion of turbine component 200 (e.g., shaped from a single piece of stock material, formed as a uniform body, etc.). In another embodiment, tip fillet 210 may be connected (e.g., bolted, welded, etc.) to tip 202 of airfoil 220. As is discussed herein, airfoil 220 and tip fillet 210 may be used in an aircraft engine, a power generation turbine, etc.

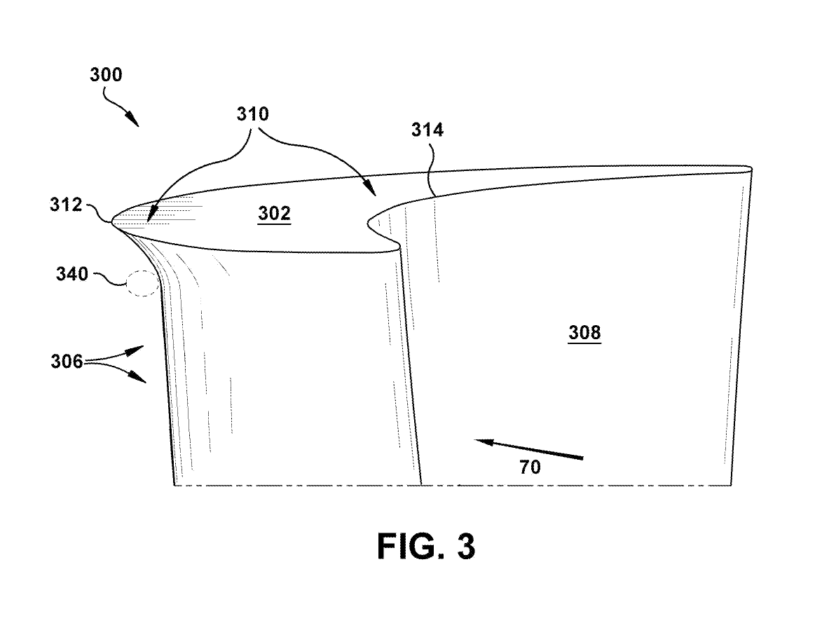

Turning to FIG. 3, a portion of a turbine blade 300 with a tip 302 including a set of tip fillets 310 is shown in accordance with embodiments. Set of tip fillets 310 include a first tip fillet 312 disposed on a first flow surface 306 of turbine blade 300, and a second tip fillet 314 disposed on a second flow surface 308 of turbine blade 300. In an embodiment, first flow surface 306 may be a suction side of turbine component 300 relative to fluid flow 70, and second flow surface 308 may be a pressure side of turbine component 300 relative to fluid flow 70. In an embodiment, at least one of first tip fillet 312 and second tip fillet 314 may have a substantially concave shape. In one embodiment, first tip fillet 312 may extend over a location of tip vortex 340 (shown in phantom) formed during operation/exposure to fluid flow 70.

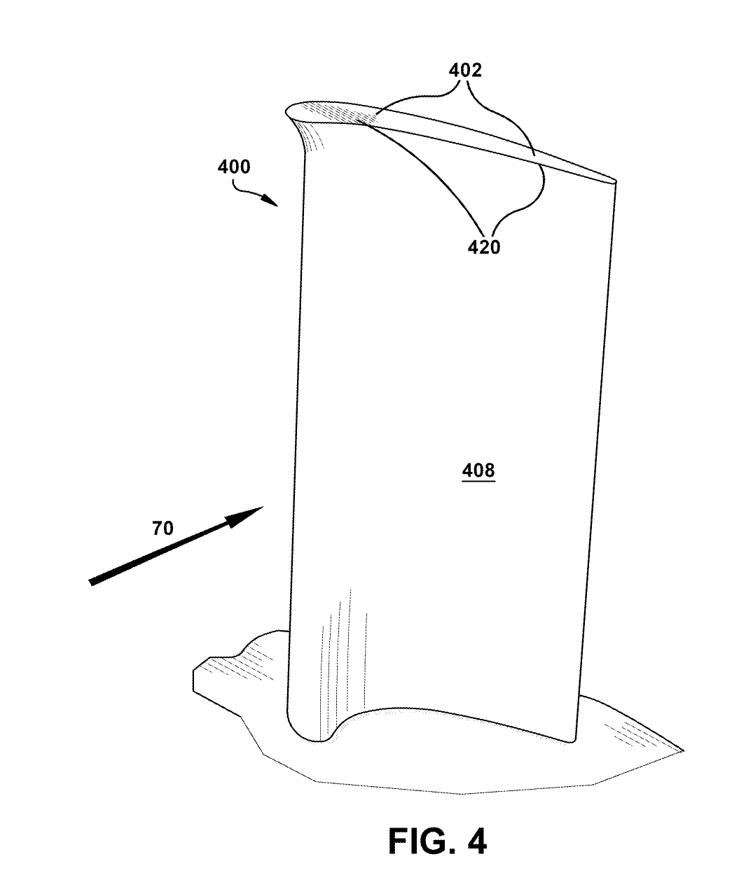

Turning to FIG. 4, a portion of a turbine blade 400 including a tip fillet 420 is shown in accordance with embodiments. Tip fillet 420 may be disposed on a second surface 408 of turbine blade 400 and may extend from a pressure side of turbine blade 400 and/or into fluid flow 70. In an embodiment, second surface 408 may be a pressure side of turbine blade 400.

Turning to FIG. 5, a two-dimensional graphical representation 500 of an embodiment of a conventional airfoil thickness function 570 is shown. Graphical representation 500 includes an x-axis 560 representing increments of an airfoil thickness dimension and a y-axis 562 representing increments of a percent radial span of the airfoil, with 0% representing a location proximate the root of the airfoil and 100% representing a location proximate a tip of the airfoil. As can be seen in FIG. 5, as a percentage of the radial span of the airfoil increases (e.g., extends from the root to the tip) from about 0% radial span to about 90% radial span, the airfoil thickness may decrease (e.g., taper, reduce in thickness, etc.). However, contrary to conventional implementations, between about 90% and about 100% of the percent of the radial span the airfoil thickness may increase as a result of a tip fillet (e.g., tip fillet 210) as indicated by a tip fillet curve/function 572 (shown in phantom). This local change in the airfoil thickness provided by tip fillet 210 near tip 202 of the airfoil may reduce tip leakage and improve turbine efficiency.

Turning to FIG. 6, a two-dimensional graphical representation 600 of an embodiment of a conventional airfoil thickness slope function 670 is shown. Graphical representation 600 includes an x-axis 660 representing increments of an airfoil thickness slope and a y-axis 662 representing increments of a percent radial span of the airfoil, with 0% representing a location proximate the root of the airfoil and 100% representing a location proximate a tip of the airfoil. Thickness slope may represent a rate of change in airfoil section thickness at any chordwise location per unit radial height and/or span. As such, a thickness slope function can reflect changes in both a pressure side and a suction side of airfoil 220.

As can be seen in FIG. 6, a typical airfoil can have a substantially constant, negative thickness slope over substantially its entire span as represented by curve 670, indicative of a taper of the airfoil from root to tip. In embodiments, however, tip fillet 210 can result in and/or be defined at least in part by a change in thickness slope, which is illustrated by example curve 672. More specifically, thickness slope can begin to increase at at least about 75% radial span, such as at at least about 80% radial span. In addition, thickness slope can continue to increase from at least about 80% radial span to about 100% radial span. Further, since in the example shown thickness slope can increase from at least about 80% radial span to about 100% radial span, the thickness of airfoil 220 can increase at a higher rate toward 100% radial span. Thus, as can be seen in FIG. 6, taper of airfoil 220 slows beginning at at least about 80% radial span (i.e., where slope begins to increase) until the thickness slope becomes positive at at least about 90% radial span, such as at at least about 95% radial span, at which point the airfoil thickness begins to increase. In an embodiment, tip fillet 210 may be construed to begin where thickness slope becomes positive, such as at at least about 95% of the radial span of the airfoil, which can also represent a point of minimum airfoil thickness, though in another embodiment, tip fillet 210 may be construed to begin where thickness slope begins to increase, such as at at least about 80% radial span. Tip fillet 210 may thicken or widen at an increasing rate between at least about 95% radial span and about 100% radial span (e.g., tip 202) so as to flare into an end wall or the like, and a profile of one or both of the suction side and the pressure side of airfoil 220 can change to effect a change in thickness slope according to embodiments.

In one embodiment, thickness slope may be calculated by Equation (1) shown below, where rad is the spanwise position of the first airfoil section, chd is the chordwise position of the first airfoil section where the airfoil thickness is to be measured, and delta_rad is a small change in span. The thickness slope can be calculated based on two measurements of airfoil thickness which are close together in span (e.g., separated by delta_rad) and can be evaluated via equation 1 as follows:

Thickness slope=(airfoil thickness (rad, chd)−airfoil thickness (rad-delta_rad, chd)/delta_{—}rad) (Eq. 1)

It should be noted that the thickness slope function shown in FIG. 6 is an example according to the teachings herein and is thus not limiting embodiments of the invention disclosed herein. As indicated above, a profile of one or both of the suction side and the pressure side of airfoil 220 can be varied to implement embodiments. In addition, while embodiments have been described in the context of a tip fillet of a rotor blade, it should be recognized that the teachings herein can be applied to implement a tip fillet of a stator blade, recognizing that in the case of a stator blade, radial span for the purposes of embodiments can increase from an outer extremity of a stator blade to an inner extremity of a stator blade.

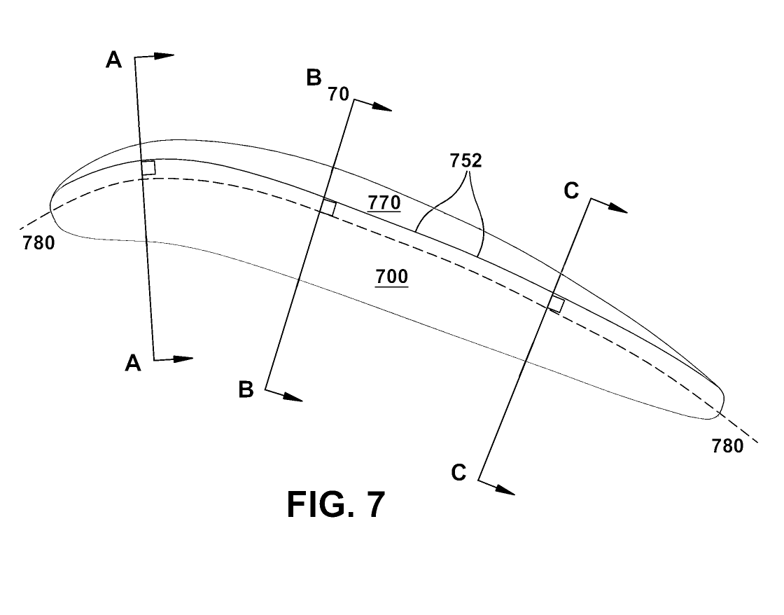

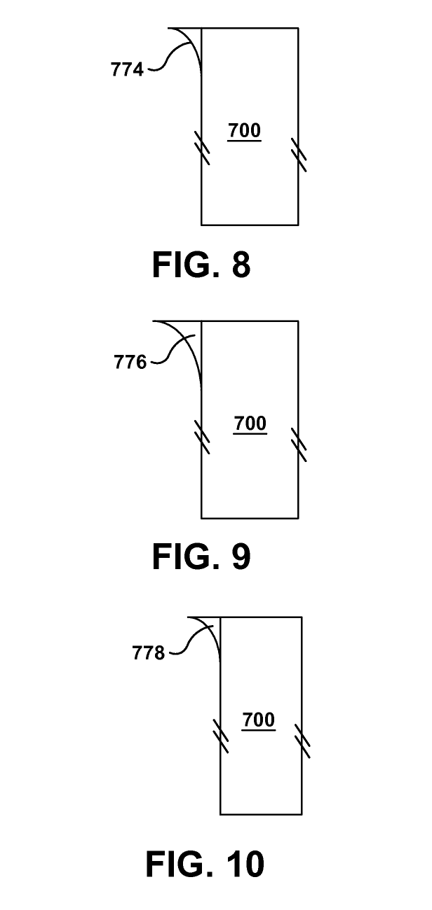

Turning to FIGS. 7-10, embodiments of portions of an airfoil 700 are shown in accordance with embodiments of the disclosure. FIG. 7 shows a top view of portions of airfoil 700. FIG. 8 shows a cross-sectional view of portions of airfoil 700 along line A-A in FIG. 7, FIG. 9 shows a cross-sectional view of portions of airfoil 700 along line B-B in FIG. 7, and FIG. 10 shows a cross-sectional view of portions of airfoil 700 along line C-C in FIG. 7.

Referring to FIG. 7, a top view radially down of an embodiment of an airfoil 700 is shown in accordance with embodiments. Airfoil 700 includes a tip fillet 770 disposed on a suction side 752 and extending into the flow path. As can be seen, tip fillet 770 is disposed substantially perpendicular relative to a camber line 780 (shown in phantom) of airfoil 700 and increases the thickness of a cross sectional tip portion of airfoil 700 relative to the thickness of a nominal/standard airfoil section.

As shown in FIGS. 8-10, tip fillet of 770 may have a varying thickness and/or shape relative to airfoil 700. This shape and/or thickness of tip fillet 770 may depend on a location of a given section of tip fillet 770 on airfoil 700. Turning to FIG. 8, a cross-sectional view of airfoil 700 along line A-A nearest a leading edge of airfoil 700 is shown according to embodiments. As can be seen, a first portion 774 of tip fillet 770 at this location on airfoil 700 proximate the leading edge has a thickness which is substantially smaller relative to a second portion 776 shown in FIG. 9 which is located proximate a mid-point of airfoil 700 between the leading and trailing edges. Similarly, third portion 778 shown in FIG. 10 and located proximate a trailing edge of airfoil 700 may have a smaller thickness than second portion 776. It is understood that a thickness and/or shape of tip fillet 770 may vary across surface 752 and that while walls of airfoil 700 are indicated as substantially parallel in FIGS. 7-10, these embodiments are merely examples and that walls of airfoil 700 may take any shape and/or relation relative one another.

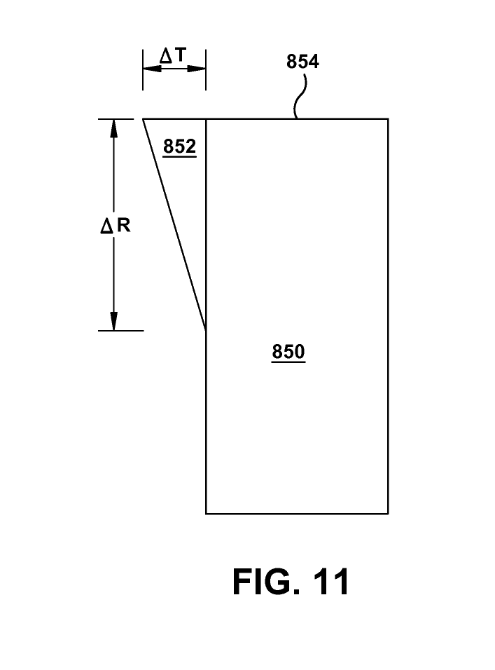

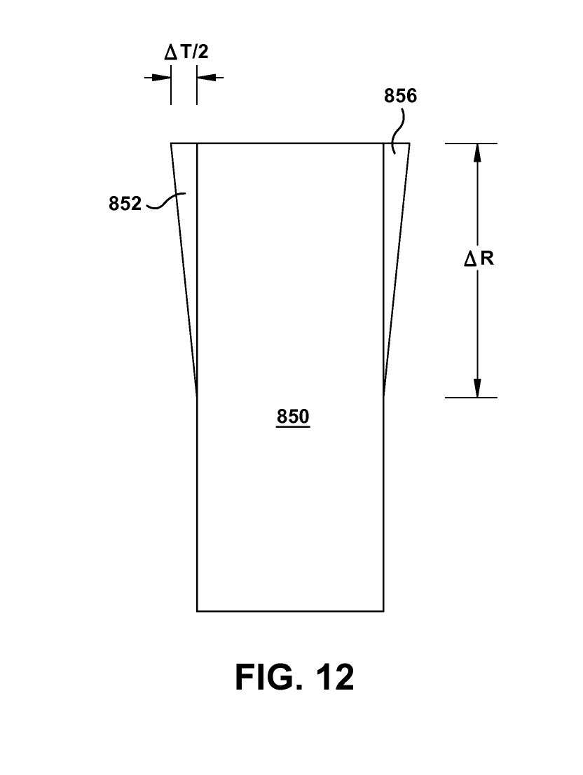

Turning to FIG. 11, an airfoil 850 is shown including a single tip fillet 852 disposed on an airfoil 850 in accordance with embodiments. In an embodiment, a thickness of tip fillet 852 may increase relative to a proximity to a tip 854 of airfoil 850. As can be seen, a rate of change of thickness ΔT may gradually increase across a rate of radial proximity AR to tip 854. In another embodiment, shown in FIG. 12, airfoil 850 includes a first tip fillet 852 and a second tip fillet 856. In an embodiment, a rate of change of thickness ΔT of airfoil 850 may be regulated by both first tip fillet 852 and second tip fillet 856. In an embodiment, each of first tip fillet 852 and second tip fillet 856 may contribute to a relative thickness of airfoil 850 across a radial span portion R. In one embodiment, at a minimum radial span R, the effect of each tip fillet may be ΔT/2. In one embodiment, tip fillet 852 may include a linear shape, a concave shape, a convex shape, and/or a point of inflection shape.

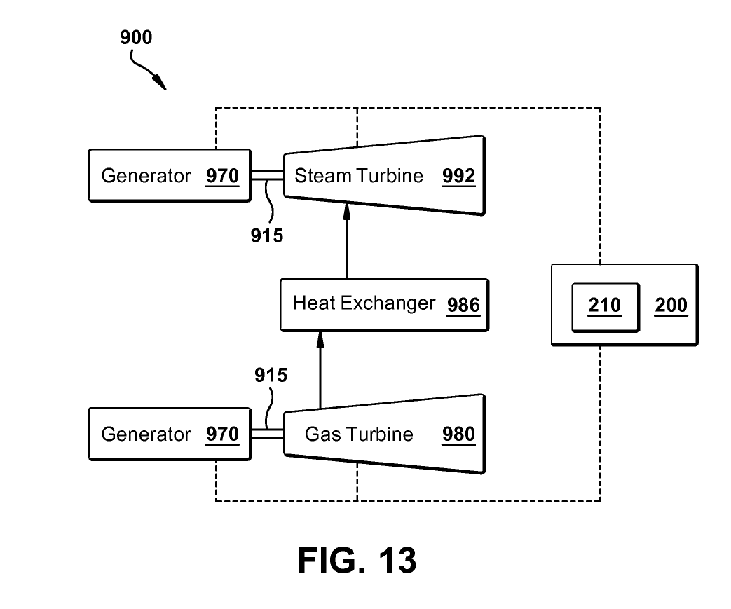

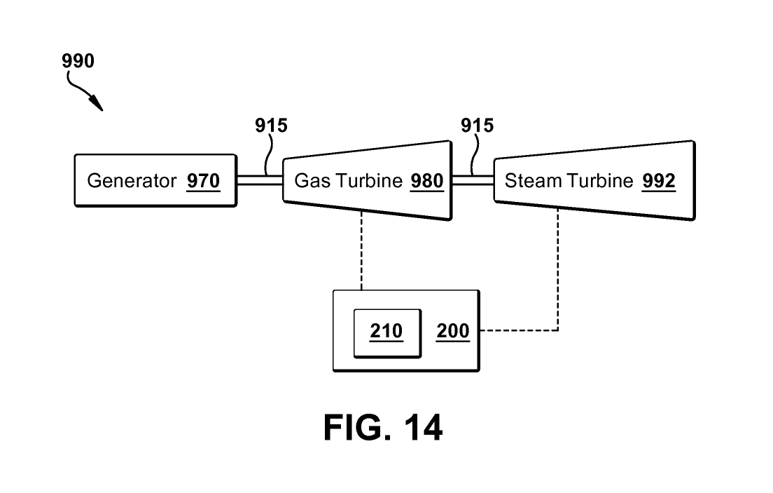

Embodiments of the invention can be used in aviation, power generation, and/or other applications and/or devices as may be desired and/or appropriate. For example, FIG. 13 shows a schematic view of portions of a multi-shaft combined cycle power plant 900 in which embodiments can be used. Combined cycle power plant 900 may include, for example, a gas turbine 980 operably connected to a generator 970. Generator 970 and gas turbine 980 may be mechanically coupled by a shaft 915, which may transfer energy between a drive shaft (not shown) of gas turbine 980 and generator 970. Also shown in FIG. 13 is a heat exchanger 986 operably connected to gas turbine 980 and a steam turbine 992. Heat exchanger 986 may be fluidly connected to both gas turbine 980 and a steam turbine 992 via conventional conduits (numbering omitted). Gas turbine 980 and/or steam turbine 992 may include tip fillet 210 of FIG. 2 or other embodiments described herein. Heat exchanger 986 may be a conventional heat recovery steam generator (HRSG), such as those used in conventional combined cycle power systems. As is known in the art of power generation, HRSG 986 may use hot exhaust from gas turbine 980, combined with a water supply, to create steam which is fed to steam turbine 992. Steam turbine 992 may optionally be coupled to a second generator system 970 (via a second shaft 915). It is understood that generators 970 and shafts 915 may be of any size or type known in the art and may differ depending upon their application or the system to which they are connected. Common numbering of the generators and shafts is for clarity and does not necessarily suggest these generators or shafts are identical. In another embodiment, shown in FIG. 14, a single shaft combined cycle power plant 990 may include a single generator 970 coupled to both gas turbine 980 and steam turbine 992 via a single shaft 915. Steam turbine 992 and/or gas turbine 980 may include tip fillet 210 of FIG. 2 or other embodiments described herein.

The apparatus and devices of the present disclosure are not limited to any one particular engine, turbine, jet engine, generator, power generation system or other system, and may be used with other aircraft systems, power generation systems and/or systems (e.g., combined cycle, simple cycle, nuclear reactor, etc.). Additionally, the apparatus of the present invention may be used with other systems not described herein that may benefit from the increased reduced tip leakage and increased efficiency of the apparatus and devices described herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A turbine blade comprising:
a root configured to connect to a turbine;
an airfoil connected to the root and configured to extend into a flowpath of the turbine, the airfoil including a tip disposed substantially opposite the root; and
a first tip fillet disposed on the tip and extending substantially away from a first surface of the turbine blade.

2. The turbine blade of claim 1, wherein the first tip fillet has a substantially concave shape.

3. The turbine blade of claim 1, wherein the first surface of the turbine blade is on one of a suction side of the turbine blade or a pressure side of the turbine blade.

4. The turbine blade of claim 3, further comprising a second tip fillet disposed on a second surface of the turbine blade, wherein the second surface is on a pressure side of the turbine blade and the first surface is on a suction side of the turbine blade.

5. The turbine blade of claim 1, wherein a thickness slope of the airfoil begins to increase at at least about 75% of a radial span of the airfoil.

6. The turbine blade of claim 5, wherein a thickness slope of the airfoil begins to increase at at least about 80% of a radial span of the airfoil.

7. The turbine blade of claim 1, wherein a thickness slope of the airfoil becomes positive at at least about 90% radial span of the airfoil.

8. The turbine blade of claim 7, wherein the thickness slope becomes positive at at least about 95% radial span of the airfoil.

9. A turbine component comprising:
a root configured to connect to a turbine;
a blade disposed on the root and configured to extend into a turbine flowpath, the blade having an airfoil shape and including a tip; and
a tip fillet connected to the tip and extending from a surface of the turbine component.

10. The turbine component of claim 9, wherein the tip fillet overhangs the blade.

11. The turbine component of claim 9, wherein the tip fillet extends beyond a tip vortex location of the turbine component.

12. The turbine component of claim 9, wherein the tip fillet has a substantially concave shape.

13. The turbine component of claim 9, wherein the tip fillet is disposed on a first surface of the turbine component, and the first surface is on one of a suction side of the turbine component or a pressure side of the turbine component.

14. The turbine component of claim 9, wherein the tip fillet extends from a surface of the turbine component in a direction substantially perpendicular to a local flow direction at points along a surface of the turbine component over the extremity of the first tip fillet.

15. The turbine component of claim 9, wherein the tip fillet includes a first portion and a second portion, the first portion disposed on a first surface on a suction side of the turbine component, and the second portion disposed on a second surface of the turbine component on a pressure side of the turbine component.

16. A turbine comprising:
a nozzle including a casing and at least one blade;
a rotor including a hub and at least one blade; and
a working fluid passage including a first portion substantially surrounded by the nozzle casing and a second portion substantially surrounding the rotor hub,
wherein each blade includes
a root configured to connect to one of the nozzle casing or the rotor hub;
an airfoil connected to the root and configured to extend into the working fluid passage of the turbine, the airfoil including a tip disposed substantially opposite the root; and
a first tip fillet disposed on the tip and extending from a surface of the turbine component in a direction substantially perpendicular to a local flow direction at points along a surface of the turbine component over the extremity of the first tip fillet.

17. The turbine of claim 16, wherein the first tip fillet of a blade includes an increasing thickness slope beginning at at least about 75% of a radial span of the blade away from the root of the blade.

18. The turbine of claim 16, wherein the first tip fillet of a blade includes a positive thickness slope beginning at at least about 90% of a radial span of the blade away from the root of the blade.

19. The turbine of claim 16, wherein the tip fillet of a blade has a substantially concave shape and is disposed on a first surface of the blade, and the respective first surface is on a suction side of the blade.

20. The turbine of claim 16, wherein the tip fillet of a blade includes a first portion and a second portion, the first portion disposed on a first surface on a suction side of the blade, and the second portion disposed on a second surface on a pressure side of the blade.
